(19) United States
(12) Patent Application Publication
(10) Pub. No.: US 2023/0196301 A1
(43) Pub. Date: Jun. 22, 2023

(54) SYSTEMS AND METHODS FOR DETERMINING AND MANAGING PROBABILITY OF ATTENDANCE

(71) Applicant: Avaya Management L.P., Durham, NC (US)

(72) Inventors: Liam Loftus, Galway (IE); Gary Collins, Galway (IE); Aaron Hurley, Galway (IE)

(21) Appl. No.: 17/559,951

(22) Filed: Dec. 22, 2021

(51) Int. Cl. G06Q 10/10

(52) U.S. Cl. CPC G06Q 10/1095

(57) ABSTRACT

Scheduling meetings should be a simple task but rarely is, especially for a large number of attendees. Meetings may be scheduled at a timeslot that affords the largest number of invitees the opportunity to attend. However, some of those invitees may have a conflict at that particular timeslot. By determining if an invitee will or will not attended the conflict, more opportunities to conduct the meeting are presented and a meeting may be scheduled at a time when the greatest number of invitees will attend.

### FIELD OF THE DISCLOSURE

The invention relates generally to systems and methods for data mining records and particularly to the dynamic discovery of erroneous indications in calendar records.

### BACKGROUND

Scheduling meetings for a large number of attendees is challenging. Multiple meeting conflicts can occur, especially where several time zones force a short window of opportunity in which the meeting can be scheduled. The organizer often has access to a basic status (e.g., busy, free, tentative, etc.) of the invitees. However, how an invitee will prioritize either an existing meeting or a new meeting contemplated by the organizer, is not known.

Some users are prone to frequently have conflicts, such as when they block off time on their calendar for recurring meetings that they do not rigorously attend. As the number of invitees increases, so too does the number of invitees that have a conflict. For example, a large company may want to conduct an “all hands” meeting to make an announcement. While it may be unrealistic to expect all employees to attend, having the greatest number of attendees may be important. As a result, meeting organizers have great difficulty scheduling such meetings so as to allow attendance by the greatest number of attendees, even when at least some of the invitees may be likely to attend a particular meeting despite the presence of a conflict on their calendar.

### SUMMARY

Merely being aware of prospective invitees' availability, as is known in the prior art, makes scheduling meetings unnecessarily difficult as such information omits knowledge of whether a current calendar item is likely to be prioritized over the new meeting or vice versa. The prior art allows for emails, phone calls, or other subsequent queries to interact with invitees, such as to receive available timeslots or offers for suggested timeslots. Usually, it is unlikely that all participants will show available in their calendar for a single timeslot when the invitee list is large, such as more than twenty, and the problem worsens as the number of potential invitees gets larger. This often requires the meeting organizer to just pick a timeslot regardless of whether a better timeslot is available, or have repeated interactions of sending out an invite after receiving an excessive number of declined responses, which may include suggestions for alternative times, and then having to send out a message cancelling the original invitation and identifying a subsequent timeslot—this too may repeat many times.

As a general introduction to the embodiments herein, and in one embodiment, systems and methods are disclosed that enable the meeting organizer, which may be fully manual, fully automated, or a combination thereof, to receive an indicia, such as a score or ranking of the likelihood invitees will attend the prospective meeting, even when a conflict exists. The invitees that have a conflict with the prospective meeting are more likely to reschedule or not attend. As one benefit, the systems disclosed herein are particularly useful when the calendars of invitees comprise instances of recurring meetings that are not always attended.

These and other needs are addressed by the various embodiments and configurations of the present invention. The present invention can provide a number of advantages depending on the particular configuration. These and other advantages will be apparent from the disclosure of the invention(s) contained herein.

By looking at invitees' past patterns of attendance for past meetings, in particular past attendance of iterations of a recurring meeting, a likelihood of attendance for a conflicting meeting, such as prospective meeting being considered by a meeting organizer, is presented. As a result, a meeting timeslot may be selected that has the greatest probability of attendance by the greatest number of invitees even though at least some of the invitees indicate the presence of a conflict.

In one embodiment, systems and methods provide a probability score of whether invitees will accept their meeting and that a meeting quorum can be formed. The probability score may be provided to a networked device of a meeting organizer or a computing device executing a meeting selection agent.

How a particular invitee is determined as being likely to attend a meeting is variously embodied and includes, but is not limited to, a machine-based determination, such as one performed by an artificial intelligence (AI) agent, evaluating one or more of the following:
Absence of conflicting meetings. If the proposed timeslot is free and within normal working hours, the invitee will be considered as attending;
Interest in the topic of discussion. For each invitee, determine whether they have accepted and attended prior meetings of similar topics. Attendance may then be determined based on a single prior attendance or a sufficient number greater than a previously determined threshold. For example, if an invitee attended one meeting but never attended again, then they may be determined as unlikely to attend, such as due to attending a first meeting and discovering the topic is not of interest. However, if a plurality of the meetings are attended, then the topic is likely to be of interest and attendance likely.
If they are a meeting organizer/chair of a current meeting. If so, they may be considered unlikely to attend a conflicting meeting.
If they are an active participant or passively ‘listen in’ to the current meetings, this may be particularly true for recurring meetings. Meetings that convey speech over a network may be transcribed and the source may be identified via an identifier of a communication device and/or voiceprint analysis to determine the degree of contribution an invitee has during past iterations of a recurring meeting. The likelihood of attendance of a conflicting meeting may be variously determined, such as inversely proportional to the contribution provided during the recurring meeting(s). A high level of contribution may indicate that the invitee is important to the previously scheduled meeting and vice versa, whereas a low level of contribution may be of less importance and/or the opportunity to get notes, action items, or other artifacts from the meeting at a later time and would be more likely to attend a new meeting.
Relationship to the meeting organizer. For example, an invitee who has an existing meeting organized by the invitee's boss or a customer is likely to attended, whereas a peer-level employee of another department is less likely to be attended.
Presence and roles of other invitees to the existing meeting. If an invitee is scheduled to attend a meeting that will also be attended by customers, direct management, company executives, etc., then they are less likely to attend a conflicting meeting.
External influences. If the invitee routinely declines all meetings at certain hours or days, the invitee may have a conflict not on their schedule, such as school runs, being out of office, etc. Accordingly, any meeting during these times would be less likely to be attended.
Actual attendance of accepted meetings. Device connection, mobile device connection to a particular area (e.g., location of a conference room), badge scans, wearable locating devices, etc., may indicate an invitee's presence during a scheduled meeting. If the invitee is not attended accepted meetings, they are more likely to be available to attend a conflicting meeting.

The above list provides one or more data points that can be mined for invitee behavior to score their likelihood to attend a prospective meeting that conflicts with an existing scheduled meeting. The data for mining may be provided from various sources, such as past calendar appointments, collaboration/conference tools (showing attendees), querying an organization's directory (e.g., lightweight directory access protocol (LDAP)) and wearable/portable devices indicating the location of the wearer. Based on these data points, a statistical or machine learning model can be built to score the likelihood of each meeting invitee attending—this scoring would be provided to the meeting organizer at the time of creating the meeting to find a timeslot that has the highest probability of most attendees joining.

In another embodiment, a message, such as an invitation to the prospective message may be or comprise an automatically generated message. The generated message may state that proposed time has been calculated as being the most likely to be accepted by the majority of invitees, therefore increasing the probability that the meeting will go ahead. And at the same time decreasing the chance that invitees will try to reschedule.

In another embodiment, a system is disclosed, comprising: a processor comprising instructions maintained in a non-transitory storage that when read by the processor cause the processor to perform: receiving a request for a prospective meeting comprising a plurality of invitees; accessing a calendaring data storage comprising data records maintaining records defining a calendar for each of the plurality of invitees each calendar comprising calendar events; for each of the plurality of invitees, determining a timeframe from a plurality of timeframes for the prospective meeting that has the largest number of the plurality of invitees determined to attend the prospective meeting; and wherein ones of the invitees are determined to attend the prospective meeting upon determining the corresponding calendar for the ones of the invitees indicates for the timeframe of the prospective meeting, at least one of, availability or a conflict and wherein the conflict is further determined to not be attended.

In another embodiment, a method is disclosed, comprising: receiving a request for a prospective meeting comprising a plurality of invitees; accessing a calendaring data storage comprising data records maintaining records defining a calendar for each of the plurality of invitees each calendar comprising calendar events; for each of the plurality of invitees, determining a timeframe from a plurality of timeframes for the prospective meeting that has the largest number of the plurality of invitees determined to attend the prospective meeting; and wherein ones of the invitees are determined to attend the prospective meeting upon determining the corresponding calendar for the ones of the invitees indicates for the timeframe of the prospective meeting, at least one of, availability or a conflict and wherein the conflict is further determined to not be attended.

In another embodiment, a system is disclosed, comprising: means to receive a request for a prospective meeting comprising a plurality of invitees; means to access a calendaring data storage comprising data records maintaining records defining a calendar for each of the plurality of invitees each calendar comprising calendar events; means to, for each of the plurality of invitees, determine a timeframe from a plurality of timeframes for the prospective meeting that has the largest number of the plurality of invitees determined to attend the prospective meeting; and wherein ones of the invitees are determined to attend the prospective meeting upon determining the corresponding calendar for the ones of the invitees indicates for the timeframe of the prospective meeting, at least one of, availability or a conflict and wherein the conflict is further determined to not be attended.

A system on a chip (SoC) including any one or more of the above embodiments or aspects of the embodiments described herein.

One or more means for performing any one or more of the above embodiments or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardwarel an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a first dialog in accordance with embodiments of the present disclosure;

FIG. 3 depicts a second dialog in accordance with embodiments of the present disclosure;

FIG. 4 depicts a first process in accordance with embodiments of the present disclosure;

FIG. 5 depicts a second process in accordance with embodiments of the present disclosure; and

FIG. 6 depicts a second system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference to one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

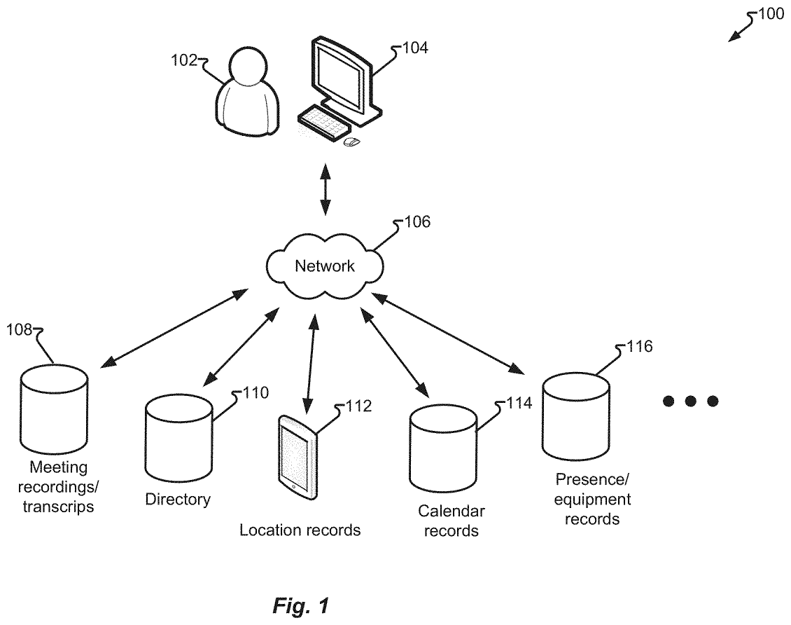

FIG. 1 depicts system 100 in accordance with embodiments of the present disclosure. In one embodiment, meeting organizer 102 interacts with computer 104 to schedule a meeting for some time in the future. Scheduling meetings, especially with a large number of invitees can become difficult as finding a time for the meeting that all invitees have available becomes less and less likely. Rather, with a significant number of invitees, some of the invitees will not be available for any acceptable timeslot for the meeting. For example, a meeting may be desired to be held during business hours or some variation of business hours (e.g., Monday-Friday before 7:00 AM and no later than 6:00 PM and not on a holiday or weekend) and/or within a particular timeframe (e.g., no sooner than next Monday and within the two weeks after). Meetings have a limited timeframe after which they become irrelevant or counterproductive. For example, attempting to obtaining a time for all employees of a large corporation to attend a particular meeting may reveal availability for all, provided one were willing to schedule the meeting several years into the future. Few, if any, meetings are open to such open-ended timeframes and rather must be held within certain limits to obtain the desired result of the meeting. For example, the purpose of a meeting is often to gather or disseminate information or determine a course of action. As a result, the meeting must be held in in time to have such a purpose remain achievable and useful. This is often more of a determining factor as to when a meeting is held as compared to finding a timeframe for the meeting that allows for all invitees to attend.

One complicating factor are the events invitees have on their calendar that they will not attend. For example, a particular timeslot may not be available, such as when records comprising the calendar for the invitee designate the timeslot as “unavailable,” “meeting,” “out of office,” etc. While embodiments herein are generally directed towards the entirety of a timeslot needed for a meeting and an invitees' status for any portion of that timeslot being indicated as unavailable would indicate the entirety of the timeslot as unavailable. It should be appreciated that, in another embodiment, a timeslot may be a portion of a meeting. For example, discuss budget for the first fifteen minutes, sales for the next fifteen minutes, production for the following fifteen minutes, and any new business for the last fifteen minutes of an hour meeting. An invitee may be invited to a portion of the meeting. For example, one invitee may be invited to a meeting that consists only of the budget portion and any conflict occurring a half an hour later not relevant.

Determining when a set of invitees is available for a meeting or other event is difficult to ascertain from calendar status alone. Generally, when an invitee has the time identified as available, they are considered to be attending the meeting. However, the actual attendance may be affected by unforeseen circumstances (e.g., family emergency, illness, bad weather, etc.) or foreseen events (e.g., a known event that has not been recorded into the calendaring system). However, one object of the embodiments herein is to determine a best available timeslot for a meeting that has the largest number of invitees attend as indicated by the calendaring system and, when the calendaring system indicates a conflict is present for a particular timeslot, determined to not attend the conflict and/or attend the new meeting for which the invitee is invited.

In one embodiment, meeting organizer 102 is in the process of finding an available time to schedule a meeting with a large number of invitees. It should be appreciated that a large number of invitees comprises at least two wherein at least one invitee has a conflict for at least one potential timeframe for the meeting, however more invitees are also contemplated. In one embodiment, computer 104 (e.g., desktop, laptop, cellular telephone, computer executing a client application component working in concert with a server executing a host component, etc.) determines which unavailable invitees for a particular timeslot will be likely to not attend the conflicting event.

In one embodiment, the conflict for at least one invitee for at least one timeslot, is an iteration of a recurring meeting wherein at least one iteration has previously occurred. Computer 104 accesses meeting recordings and transcripts 108 to determine whether the invitee contributed to a prior meeting. For example, if the meeting was recorded, such as via a recording device or a recording service for a virtual meeting, such recordings may be analyzed via performing a voiceprint analysis and comparing the speakers with known speaker voiceprints, indicate that speech. If the invitee provided speech to the recording that is determined to be significant, then the conflicting meeting may be important and will attend the conflict. The determination of whether the speech provided to a recording is significant is variously embodied and may include one or more of time (e.g., at least a previously determined threshold amount of speech as provided by the invitee), ratio (e.g., of all the speech of all the participants, the invitee provided at least an average amount of the speech), questions that were answered, answers to questions, etc. In contrast, some speech may be readily determined to not be significant (e.g., stating one's name, position, or other general or static information). Similar to a recording, meeting recordings and transcripts 108 may comprise a transcript and, providing speakers are identified, the transcript may be utilized in place of the recording to determine whether significant speech was provided by the invitee.

In another embodiment, computer 104 accesses directory 110 to determine whether one or more attendees are very important persons (VIPs). A VIP may be the invitee's immediate or higher-level manager or other person of authority over the invitee (e.g., customer). If a VIP is scheduled to attend the prospective meeting, the invitee is unlikely to miss it and, therefore, determined to be likely to attend the conflict and not attend the new meeting. If a VIP is the presenter, organizer, or has another designation beyond merely attending the conflict, the invitee is more likely to attend the conflict. Conversely, if all invitees are peers or subordinates, the invitee may be determined to be less interested in the conflict and less likely to attend the conflict and/or less likely to attend the meeting that is the subject of the prospective invitation.

Whether an invitee has attended similar meetings (e.g., iterations of a recurring meeting) in the past may be determined via location services. For example, location records 112 may be maintained in a wearable/portable device closely associated with the invitee (e.g., cellular telephone, access card/badge, wearable device with position information, etc.). Location records 112 may indicate the invitee attends the recurring meeting when location records 112 indicates that the wearable/portable device is co-located with the site of the meeting (e.g., in a particular building for which the invitee's badge was scanned, a wireless connection established with an access point having a range substantially limited to the location of the recurring meeting, geolocation service of a wearable device indicating presence at the recurring meeting, etc.). In another embodiment, absence of attendance may be determined, such as when location records 112 indicates the presence at a location known to differ from that of the recurring meeting. If the invitee is known to attended the recurring meeting, the invitee may be likely to attended the conflict and/or less likely to attend the meeting that is the subject of the prospective invitation.

In another embodiment, computer 104 accesses calendar records 114 to determine whether a pattern of attendance is indicated for meeting having particular time and/or day attributes. For example, computer 104 may determine that an invitee may accept meetings scheduled at a particular time of day (e.g., 4:00 PM) but never or rarely attends, such as due to after school obligations. Accordingly, when the timeslot for a prospective meeting occurs during such times of frequent non-attendance, a conflict may not be attended, however attendance of the prospective meeting may be considered similarly unlikely.

In another embodiment, computer 104 accesses presence and equipment records 116 such as to obtain records of equipment usages. For example, if a recurring meeting is conducted via a network, but the conferencing equipment and/or software indicates that the invitee does not join such meetings, then the invitee may be considered to be unlikely to attend the conflict and/or more likely to attend the meeting that is the subject of the prospective invitation.

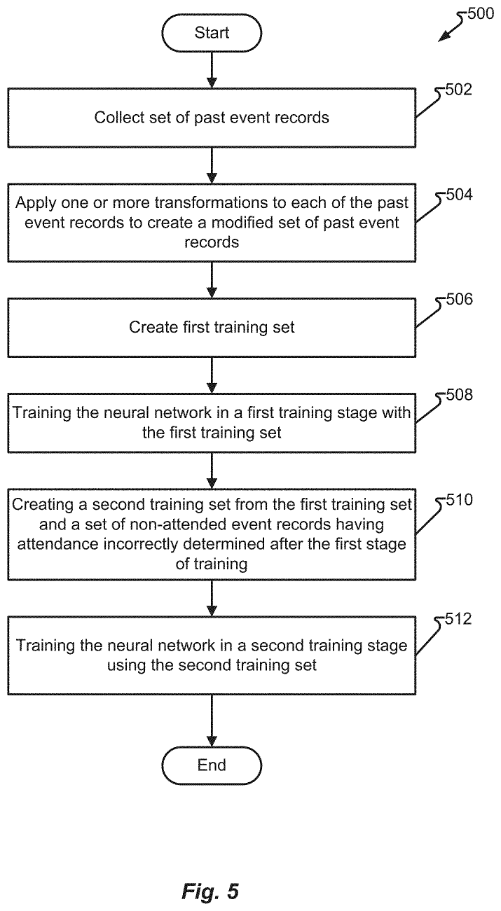

In one embodiment, an algorithmic determination may be made upon gathering information from one or more data sources (e.g., meeting recordings and transcripts 108, directory 110, location records 112, calendar records 114, presence and equipment records 116, and/or other data sources having presence determining or indicating records therein) as to whether an invitee will attend a conflict and/or attend a prospective meeting. However, in other embodiments, such a determination is more nebulous. Accordingly, an AI, such as a neural network trained on such presence information obtained from the data sources, may be provided a determination as to whether an invitee with a conflict will attend the conflict or not attend the conflict and, if not attending the conflict, will attend the prospective meeting. Accordingly, the neural network, such as that described with respect to FIG. 5, may be further provided actual attendance information (e.g., invitee survey, meeting host questionnaire, sign-in to a conferencing service, etc.) to refine predictions for subsequent prospective meetings.

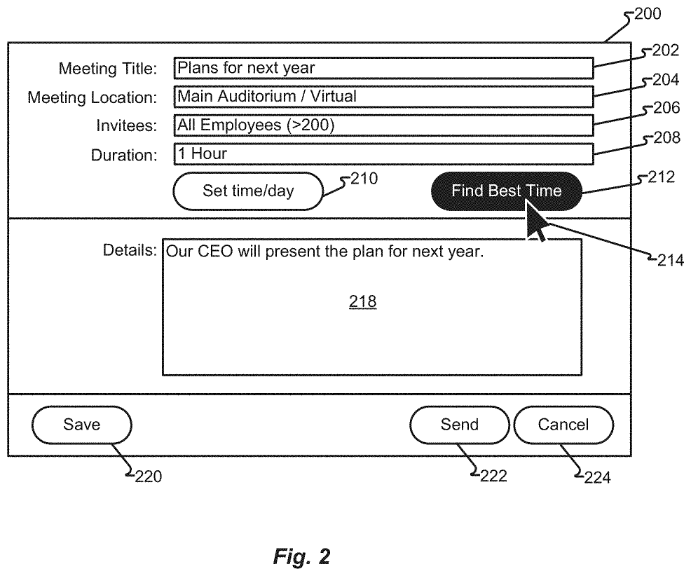

FIG. 2 depicts dialog 200 in accordance with embodiments of the present disclosure. In one embodiment, computer 104 comprises at least one processor executing instructions, such as to communicate with one or more data sources and receive inputs via a user interface to select a timeslot for a prospective meeting comprising a plurality of invitees as presented on a display attached to or in communication with computer 104. Dialog 200 may gather, via user input via an input-output device associated with computer 104 and/or other source (e.g., a data storage maintaining meeting invitation previously saved), attributes of the prospective meeting. Attributes may include title 202, location 204, invitees 206, duration 208, details 218, and/or other attributes. If a meeting has a fixed time, without consideration of availability, the fixed timeslot (e.g., time and date) may be input, such as via a dialog (not shown) triggered by an input to button 210.

In another embodiment, meeting organizer 102 may wish to have the greatest number of attendees and trigger, such as via a mouse or other pointing device directing pointer 214 and the selection of button 212, to cause computer 104 to identify and/or select the best timeslot to do so. Once the invite is complete, the invitation may be sent via an input to button 222. The dialog 200 may be cancelled without sending or saving the invite via an input to button 224 and the invitation may be saved without sending via an input to button 220.

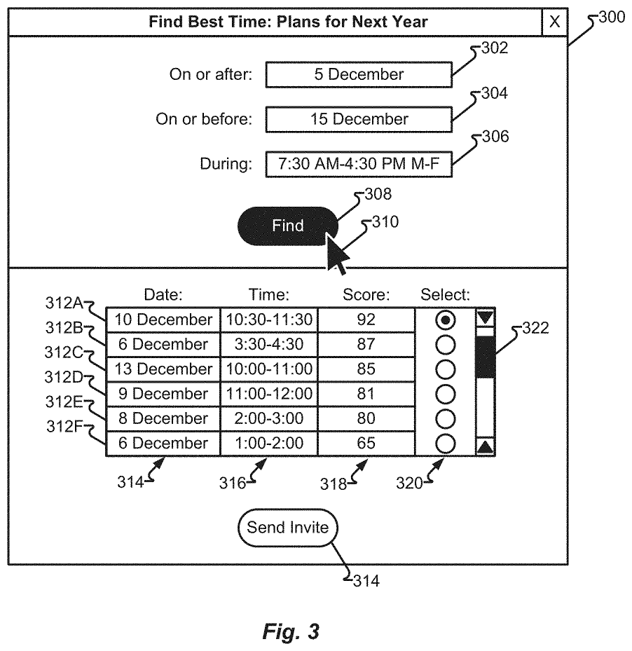

FIG. 3 depicts dialog 300 in accordance with embodiments of the present disclosure. In one embodiment, computer 104 comprises at least one processor executing instructions, such as to communicate with one or more data sources and receive inputs via a user interface to select a timeslot for a prospective meeting comprising a plurality of invitees as presented on a display attached to or in communication with computer 104. In one embodiment, computer 104 automatically identifies when most invitees will attend a prospective meeting and presents indicia of the meeting in dialog 300. Dialog 300 may itself be triggered by a dialog, such as an input to button 212 (see FIG. 2).

In one embodiment, and prior to presenting the results identifying the most attendees for a prospective meeting, dialog 300 may gather some preliminary information. For example, field 302 may identify a “no earlier than” date or time and field 304 may identify a “no later than” date or time. Field 306 may determine bounds for the meeting (e.g., during regular business hours, weekends, no weekends, etc.). With such preliminary information an input, such as via pointer 310 on button 308, causes the processor of computer 104 to identify the timeslots with the most invitees that will attend.

In another embodiment, results are presented. The results may comprise a number of indicia of timeslots 312A-312F. It should be appreciated that more or fewer indicia of timeslots 312 may be presented without departing from the scope of the embodiments herein. Results may include indicia of timeslots 312, each of which may comprise additional information such as, time 314, date 316, score 318, and selection 320. Additional indicia of timeslots, when available, may be accessed, such as via an input to slider 322.

A processor of computer 104 may move each indicia of timeslots 312 into a position of prominence most readily identified, such as the top of a listing, closest to a previously determined position of prominence, etc., wherein the position of each indicia of timeslots 312 is determined by the score 318. Score 318 may be a number of invitees determined to attend and/or an aggregation of confidence of attendance. For example, one invitee may have a particular timeslot available and be able to attend. As a result, the confidence that the invitee will be an attendee is high, for example 98 out of 100. However, for each invitee meetings accepted and/or meetings for which no conflict exists may not be attended, such as due to unforeseen or unrecorded conflicts. The confidence that an invitee will attend the prospective meeting may be lower if a conflict is present, but determined unlikely to attend. The confidence may be lower still if the invitee has a confidence they are determined likely to attend. As a result score 318 may reflect an aggregation of the probability of attendance for all invitees and be positioned relative to the location of prominence accordingly.

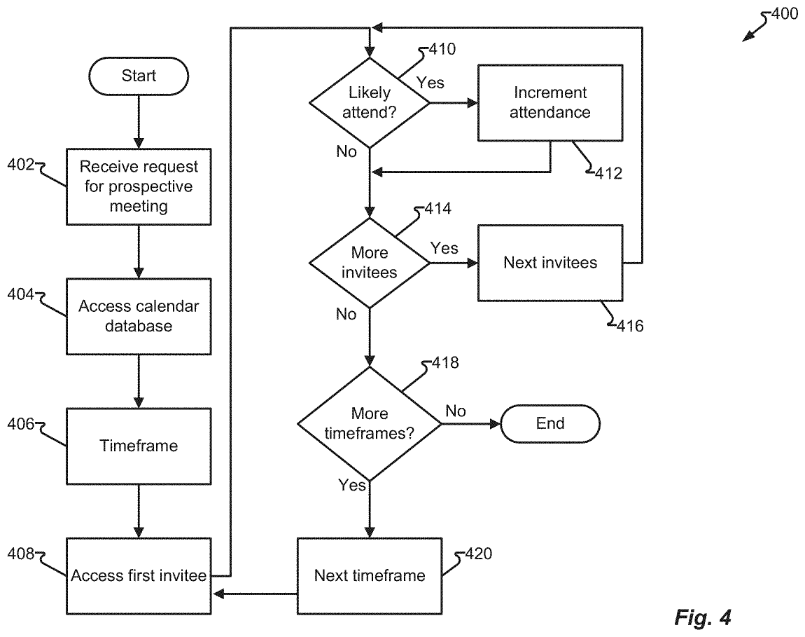

FIG. 4 depicts process 400 in accordance with embodiments of the present disclosure. In one embodiment, process 400 is embodied as machine-readable instructions maintained in a non-transitory storage that when ready by a processor, such as a processor of computer 104 or other computing device(s), cause the processor to perform the steps of process 400. Process 400 begins and, in step 402 receives a request to schedule a prospective meeting, such as via dialog 200 and/or dialog 300 (see, FIGS. 2 and 3). Step 404 accesses a calendar database and, step 406 accesses a timeframe for the meeting (see dialog 300, FIG. 3). The timeframe may be one of each timeframe-duration window (see dialog 300, FIG. 3) within any other limitations identified (e.g., only within normal business hours, etc.).

Step 408 accesses calendar records for a first invitee and, in test 410, determines if the associated invitee is likely to attend the prospective meeting if held at the particular timeframe. to determine whether each of the invitees has a particular timeslot available. Test 410 may be determined in the affirmative if the invitee has availability indicated by records of the calendar database that coincide with the timeslot. Test 410 may also be determined in the affirmative if the invitee has a conflict indicated by the records of the calendar database that coincide with the timeslot but is further determined not to attend the conflict and/or attended the prospective meeting. If test 410 is determined in the affirmative, step 412 increments the attendance count. Additionally or alternatively, step 412 increments the attendance count by a proportion indicative of the confidence that the invitee will not attend the conflict and/or will attend the prospective meeting.

After step 412, or if test 410 is determined in the negative, test 414 determines if more invitees exist and, if determined in the affirmative, process 400 increments to the next invitee in step 416 and processing loops back to test 410. If test 414 is determined in the negative, processing continues to step 418 to determine if there are more timeframes. If test 418 is determined in the affirmative, then step 420 increments to the next timeframe. Step 420 may increment to the next timeframe in a predefined increment (e.g., five minutes, fifteen minutes, half hour, hour, etc.) and processing loops back to step 408. If test 418 is determined in the negative, process 400 ends, such as to report results (see, FIG. 3).

FIG. 5 depicts process 500 in accordance with embodiments of the present disclosure. In one embodiment, process 500 is embodied as machine-readable instructions maintained in a non-transitory storage that when ready by a processor, such as a processor of computer 104 or other computing device(s), cause the processor to perform the steps of process 500. A neural network, as is known in the art and in one embodiment, self-configures layers of logical nodes having an input and an output. If an output is below a self-determined threshold level, the output is omitted (i.e., the inputs are within the inactive response portion of a scale and provide no output), if the self-determined threshold level is above the threshold, an output is provided (i.e., the inputs are within the active response portion of a scale and provide an output), the particular placement of the active and inactive delineation is provided as a training step or steps. Multiple inputs into a node produce a multi-dimensional plane (e.g., hyperplane) to delineate a combination of inputs that are active or inactive. Once trained, the neural network may be presented with attributes of a prospective meeting (e.g., time of day, day of week, attendees, presenter, organizer, etc.) and receive from the neural network an attendance decision. The decision may be based, at least in part, on the prospective meeting alone and/or attributes of a conflicting event (e.g., time of day, day of week, attendees, presenter, organizer, prior attendance of occurrences of a recurring meeting, etc.). The neural network may return an attendance prediction that is binary (will or will not attend the conflict) and/or a probability (e.g., 73% chance of attending the conflict). From the neural network, a selection may be made based on those invitees who will or will likely attend even if a conflict exists.

Process 500 begins and, in step 502, collects a set of past event records. For example, step 502 may access calendar records 114 to collect events and attributes of the events (e.g., one time versus one of a set of recurring events, time of the event, day of event, etc.) and/or attendance of such events. Attendance may be determined by querying a transcript or meeting recording (see, meeting recordings and transcripts 108), querying a location record of a wearable/portable device carried by an invitee (see, location records 112), querying a usage record of location-indicating equipment (e.g., access point, badge-access controlled door, networking equipment, conferencing equipment, etc.), and/or other attendance indicating component or records.

Step 504 applies one or more transformations to each of the past event records to create a modified set of past event records. Transformations include, but are not limited to, changing a changing attendance, time of day, changing day of week, changing attendance of a superior, changing the presenter, and changing the organizer. Step 506, a first training set comprising the set of event records and the modified set of event records which is then utilized to train the neural network in a first training state in step 508.

Step 510 creates a second training set from the first training set and a set of non-attended event records having attendance incorrectly determined after the first training stage (step 508). Step 512 trains the neural network in a second training stage using the second training set.

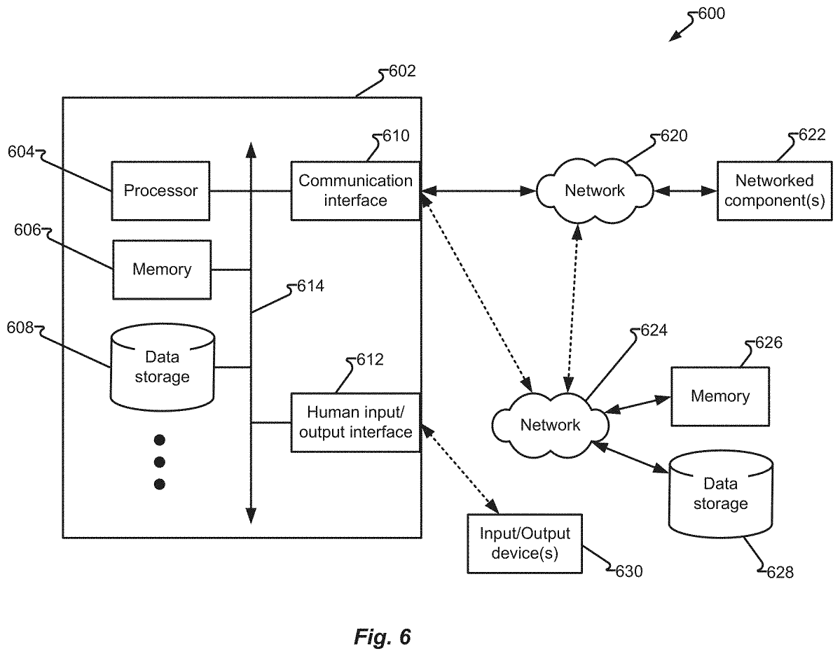

FIG. 6 depicts device 602 in system 600 in accordance with embodiments of the present disclosure. In one embodiment, computer 104 may be embodied, in whole or in part, as device 602 comprising various components and connections to other components and/or systems. The components are variously embodied and may comprise processor 604. The term “processor,” as used herein, refers exclusively to electronic hardware components comprising electrical circuitry with connections (e.g., pin-outs) to convey encoded electrical signals to and from the electrical circuitry. Processor 604 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 614, executes instructions, and outputs data, again such as via bus 614. In other embodiments, processor 604 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 604 is a non-transitory computing device (e.g., electronic machine comprising circuitry and connections to communicate with other components and devices). Processor 604 may operate a virtual processor, such as to process machine instructions not native to the processor (e.g., translate the VAX operating system and VAX machine instruction code set into Intel® 9xx chipset code to enable VAX-specific applications to execute on a virtual VAX processor), however, as those of ordinary skill understand, such virtual processors are applications executed by hardware, more specifically, the underlying electrical circuitry and other hardware of the processor (e.g., processor 604). Processor 604 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 604, device 602 may utilize memory 606 and/or data storage 608 for the storage of accessible data, such as instructions, values, etc. Communication interface 610 facilitates communication with components, such as processor 604 via bus 614 with components not accessible via bus 614. Communication interface 610 may be embodied as a network port, card, cable, or other configured hardware device. Additionally or alternatively, human input/output interface 612 connects to one or more interface components to receive and/or present information (e.g., instructions, data, values, etc.) to and/or from a human and/or electronic device. Examples of input/output devices 630 that may be connected to input/output interface include, but are not limited to, keyboard, mouse, trackball, printers, displays, sensor, switch, relay, speaker, microphone, still and/or video camera, etc. In another embodiment, communication interface 610 may comprise, or be comprised by, human input/output interface 612. Communication interface 610 may be configured to communicate directly with a networked component or utilize one or more networks, such as network 620 and/or network 624.

Network 106 may be embodied, in whole or in part, as network 620. Network 620 may be a wired network (e.g., Ethernet), wireless (e.g., WiFi, Bluetooth, cellular, etc.) network, or combination thereof and enable device 602 to communicate with networked component(s) 622. In other embodiments, network 620 may be embodied, in whole or in part, as a telephony network (e.g., public switched telephone network (PSTN), private branch exchange (PBX), cellular telephony network, etc.)

Additionally or alternatively, one or more other networks may be utilized. For example, network 624 may represent a second network, which may facilitate communication with components utilized by device 602. For example, network 624 may be an internal network to a business entity or other organization, whereby components are trusted (or at least more so) that networked components 622, which may be connected to network 620 comprising a public network (e.g., Internet) that may not be as trusted.

Components attached to network 624 may include memory 626, data storage 628, input/output device(s) 630, and/or other components that may be accessible to processor 604. For example, memory 626 and/or data storage 628 may supplement or supplant memory 606 and/or data storage 608 entirely or for a particular task or purpose. For example, memory 626 and/or data storage 628 may be an external data repository (e.g., server farm, array, “cloud,” etc.) and enable device 602, and/or other devices, to access data thereon. Similarly, input/output device(s) 630 may be accessed by processor 604 via human input/output interface 612 and/or via communication interface 610 either directly, via network 624, via network 620 alone (not shown), or via networks 624 and 620. Each of memory 606, data storage 608, memory 626, data storage 628 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 630 may be a router, switch, port, or other communication component such that a particular output of processor 604 enables (or disables) input/output device 630, which may be associated with network 620 and/or network 624, to allow (or disallow) communications between two or more nodes on network 620 and/or network 624. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARIV1926EJS™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a processor comprising instructions maintained in a non-transitory storage that when read by the processor cause the processor to perform:
receiving a request for a prospective meeting comprising a plurality of invitees;
accessing a calendaring data storage comprising data records maintaining records defining a calendar for each of the plurality of invitees each calendar comprising calendar events;
for each of the plurality of invitees, determining a timeframe from a plurality of timeframes for the prospective meeting that has the largest number of the plurality of invitees determined to attend the prospective meeting; and
wherein ones of the invitees are determined to attend the prospective meeting upon determining the corresponding calendar for the ones of the invitees indicates for the timeframe of the prospective meeting, at least one of, availability or a conflict and wherein the conflict is further determined to not be attended.

2. The system of claim 1, wherein for ones of the invitees the processor determines whether the conflict will not be attended further comprises, upon determining the conflict is an instance of a recurring event, further determining ones of the invitees did not attended a number of prior instances of the recurring event that greater than a previously defined threshold.

3. The system of claim 1, wherein for ones of the invitees the processor determines whether the conflict will not be attended further comprises, upon determining the conflict is an instance of a recurring event, further determining ones of the invitees did not actively participant in a number of prior instances of the recurring event that greater than a previously defined threshold.

4. The system of claim 1, wherein for ones of the invitees the processor determines whether the conflict will not be attended further comprises, upon determining the conflict is a meeting having an identified presenter that does not match the ones of the invitees.

5. The system of claim 1, wherein for ones of the invitees the processor determines whether the conflict will not be attended further comprises, upon determining the conflict is a meeting having an identified meeting organizer that does not match the ones of the invitees.

6. The system of claim 1, further comprising the processor:
accessing an organizational structure record;
determining, for ones of the invitees having the corresponding calendar indicating the conflict with the prospective meeting further comprises the conflict having a very important person in attendance and wherein the very important person is identified as a superior within the organizational structure record; and
wherein the ones of invitees are determined not to attend the conflict upon the conflict being determined to be devoid a very important person.

7. The system of claim 1, wherein the processor determines whether ones of the invitees having the corresponding calendar indicating the conflict with the prospective meeting further comprises the processor providing the prospective meeting to a neural network trained to determine a likelihood of attendance and receiving an attendance decision for the conflict therefrom.

8. The system of claim 7, wherein the processor further performs:
collecting a set of past event records from a database scheduled for a number of invitees;
applying one or more transformations to each past event including changing attendance, a time of day, changing day of week, changing attendance of a superior, changing the presenter, changing the organizer, to create a modified set of past meeting records;
creating a first training set comprising the collected set of past event records, the modified set of past event records, and a set of non-attended event records;
training the neural network in a first stage using the first training set;
creating a second training set for a second stage of training comprising the first training set and the set of non-attended event records that have attendance incorrectly determined; and
training the neural network in the second stage using the second training set.

9. The system of claim 8, wherein the set of non-attended event records comprises the set of past event records that comprise indicia of attendance for at least one invitee that was absent therefrom.

10. The system of claim 1, wherein the processor automatically moves indicia of each of a plurality of candidate timeslots for the prospective meeting closets to a starting location based on the number of the plurality invitees determined to attend.

11. A method, comprising:
receiving a request for a prospective meeting comprising a plurality of invitees;
accessing a calendaring data storage comprising data records maintaining records defining a calendar for each of the plurality of invitees each calendar comprising calendar events;
for each of the plurality of invitees, determining a timeframe from a plurality of timeframes for the prospective meeting that has the largest number of the plurality of invitees determined to attend the prospective meeting; and
wherein ones of the invitees are determined to attend the prospective meeting upon determining the corresponding calendar for the ones of the invitees indicates for the timeframe of the prospective meeting, at least one of, availability or a conflict and wherein the conflict is further determined to not be attended.

12. The method of claim 11, wherein determining whether, for ones of the invitees, the conflict will not be attended further comprises, upon determining the conflict is an instance of a recurring event, determining ones of the invitees did not attended a number of prior instances of the recurring event that greater than a previously defined threshold.

13. The method of claim 11, determining whether, for ones of the invitees, the conflict will not be attended further comprises, upon determining the conflict is an instance of a recurring event, determining ones of the invitees did not actively participant in a number of prior instances of the recurring event that greater than a previously defined threshold.

14. The method of claim 11, wherein determining whether, for ones of the invitees, the conflict will not be attended further comprises determining whether the conflict is a meeting having an identified presenter that does not match the ones of the invitees.

15. The method of claim 11, wherein determining whether, for ones of the invitees, the conflict will not be attended further comprises determining whether the conflict is a meeting having an identified meeting organizer that does not match the ones of the invitees.

16. The method of claim 11, further comprising:
accessing an organizational structure record;
determining, for ones of the invitees having the corresponding calendar indicating the conflict with the prospective meeting further comprises the conflict having a very important person in attendance and wherein the very important person is identified as a superior within the organizational structure record; and
wherein the ones of invitees are determined not to attend the conflict upon the conflict being determined to be devoid a very important person.

17. The method of claim 11, wherein determining whether, for ones of the invitees, the corresponding calendar indicating the conflict with the prospective meeting further comprises providing the prospective meeting to a neural network trained to determine a likelihood of attendance and receiving an attendance decision for the conflict therefrom.

18. The method of claim 17, further comprising:
collecting a set of past event records from a database scheduled for a number of invitees;
applying one or more transformations to each past event including changing attendance, a time of day, changing day of week, changing attendance of a superior, changing the presenter, changing the organizer, to create a modified set of past meeting records;
creating a first training set comprising the collected set of past event records, the modified set of past event records, and a set of non-attended event records;
training the neural network in a first stage using the first training set;
creating a second training set for a second stage of training comprising the first training set and the set of non-attended event records that have attendance incorrectly determined; and
training the neural network in the second stage using the second training set.

19. The method of claim 11, further comprising
receiving, via a graphical user interface, a user selection to organize each icon based on a specific criteria, wherein the specific criteria is the number of the plurality of invitees determine to attend a prospective meeting occurring at a particular timeslot; and
automatically moving the most used icons to a position on the graphical user interface closest to a previously determined prominent location on the graphical user interface based on the number of the plurality of invitees determine to attend.

20. A system, comprising:
means to receive a request for a prospective meeting comprising a plurality of invitees;
means to access a calendaring data storage comprising data records maintaining records defining a calendar for each of the plurality of invitees each calendar comprising calendar events;
means to, for each of the plurality of invitees, determine a timeframe from a plurality of timeframes for the prospective meeting that has the largest number of the plurality of invitees determined to attend the prospective meeting; and
wherein ones of the invitees are determined to attend the prospective meeting upon determining the corresponding calendar for the ones of the invitees indicates for the timeframe of the prospective meeting, at least one of, availability or a conflict and wherein the conflict is further determined to not be attended.
